(19) United States
(12) Patent Application Publication
(10) Pub. No.: US 2026/0257292 A1
(43) Pub. Date: Sep. 3, 2026

(54) SOLDER SUPPLY DEVICE, SOLDER SUPPLY METHOD AND PRINTING APPARATUS

(71) Applicant: YAMAHA HATSUDOKI KABUSHIKI KAISHA, Iwata-shi, Shizuoka (JP)

(72) Inventor: Yoshiki SAITO, Iwata-shi, Shizuoka (JP)

(73) Assignee: YAMAHA HATSUDOKI KABUSHIKI KAISHA, Iwata-shi, Shizuoka (JP)

(21) Appl. No.: 18/880,165

(22) PCT Filed: Jul. 13, 2022
(86) PCT No.: PCT/JP2022/027564

§ 371 Date: Dec. 30, 2024

(51) Int. Cl. B23K 3/06

(52) U.S. Cl. CPC B23K 3/0638

(57) ABSTRACT

A solder supply device comprising a storage pot, a mover, a mover drive mechanism and a controller. The storage pot includes a storage space for storing solder and a discharge port in a bottom part to communicate with the storage space and discharge the solder downward from the discharge port. The mover moves in a vertical direction in the storage space while covering the solder stored in the storage space from above. The mover drive mechanism includes a first opening/closing part for switching pressure feed and pressure feed stop of air to a non-storage region and configured to push down the mover by feeding the air under pressure to the non-storage region through the first opening/closing part, the non-storage region being located above the mover in the storage space. The controller controls the mover drive mechanism to discharge the solder from the discharge port by pushing down the mover.

### CROSS-REFERENCE TO RELATED APPLICATION

This application is a National Stage of International Patent Application No. PCT/JP2022/027564, filed Jul. 13, 2022, the entire contents of which is incorporated herein by reference.

### BACKGROUND

### Technical Field

This disclosure relates to a solder supply technique for supplying solder stored in a storage pot by discharging the solder from a discharge port provided in a bottom part of the storage pot and a printing apparatus for printing solder supplied by the solder supply technique.

### Background Art

A printing apparatus is known which prints solder on a board overlapped on the lower surface of a mask plate by moving the solder on the upper surface of the mask plate. This printing apparatus is equipped with a solder supply device for supplying paste-like solder (may be called “solder paste”) to the mask plate. For example, in JP 2015-174119A, an inner lid is movably arranged in a container constituting the storage pot. The solder is discharged downward from the tip of a through hole, i.e. a discharge port, provided in a bottom part of the container by a pushing member having a diameter smaller than an inner diameter of the container pushing down the inner lid.

### SUMMARY

In the apparatus described in JP 2015-174119A, a pressing cylinder is fixedly arranged above the storage pot to move the pushing member into and out from the container. Accordingly, a relatively large space needs to be ensured above the storage pot to install the pressing cylinder, which becomes one of main factors causing an apparatus size increase in a vertical direction and, consequently, becomes one of drawbacks in reducing the size of the printing apparatus.

This disclosure was developed in view of the above problem and aims to provide a solder supply technique capable of reducing the size of an apparatus and a printing apparatus equipped with such a technique.

A first aspect of the disclosure is a solder supply device. The device comprises a storage pot including a storage space capable of storing solder and a discharge port provided in a bottom part to communicating with the storage space, the solder being dischargeable downward from the discharge port; a mover movable in a vertical direction in the storage space while covering the solder stored in the storage space from above; a mover drive mechanism including a first opening/closing part for switching pressure feed and pressure feed stop of air to a non-storage region and configured to push down the mover by feeding the air under pressure to the non-storage region by way of the first opening/closing part, the non-storage region located above the mover in the storage space; and a controller configured to control the mover drive mechanism to discharge the solder from the discharge port by pushing down the mover.

A second aspect of the disclosure is a solder supply method. The method comprises providing a mover movably in a vertical direction in a storage space while covering solder from above for the storage pot having the solder stored in the storage space; and feeding air under pressure to a non-storage region above the mover in the storage space, thereby increasing a pressure in the non-storage region and discharging the solder from a discharge port communicating with a bottom part of the storage space by pushing down the mover according to a pressure increase.

A third aspect of the disclosure is a printing apparatus. The apparatus comprises the solder supply device configured to supply solder to a surface of a mask overlapped on a board, and a printing mechanism configured to printing the solder on the board in a pattern corresponding to the mask by moving the solder supplied form the solder supply device on the surface of the mask.

In the disclosure thus configured, the air press-fed into the non-storage region via the first opening/closing part pushes the moving body down, which causes solder to be discharged from the discharge port. Therefore, the solder supply device can be downsized in the vertical direction compared to conventional device that uses a pressing cylinder to push down the mover.

Here, the storage pot may include a concave-shaped container having an inside functioning as the storage space while being open upward, the storage pot being provided with the discharge port in the bottom part. The mover may include an inner lid movable in the vertical direction while a side surface thereof slides in contact with an inner wall of the container and a lower surface thereof is held in contact with a liquid surface of the solder; and a moving member movable in the vertical direction integrally with the inner lid in a state placed on an upper surface of the inner lid. The mover drive mechanism may further include an outer lid to be mounted on the container to close an opening of the container with the inner lid and the moving member inserted in the storage space. The first opening/closing part may be connected to the outer lid to communicate with the non-storage region sandwiched by the outer lid and the moving member. In other words, when the storage pot is provided with the inner lid inserted into the storage space, the inner lid may be used as one component of the mover, and by using the inner lid as the mover, solder can be discharged while inhibiting residual solder on the inner wall of the container. In addition, the outer lid is attached to the container to seal the opening of the container, allowing the solder to be pushed down efficiently by the mover.

The outer lid may be attachable to and detachable from the container. In this case, when the solder is used up, the moving member can be removed from the storage space by removing the outer lid. Furthermore, the moving member may include a lower surface to be held in contact with the upper surface of the inner lid, an upper surface facing the non-storage region and a projecting member projecting from a central part of the upper surface toward the opening of the container. The presence of the projecting member facilitates the work of placing and removing the moving member on the inner lid.

The storage pot may include a concave-shaped container having an inside functioning as the storage space while being open upward, the storage pot being provided with the discharge port in the bottom part. The mover may include a moving member movable in the vertical direction while a side surface thereof slides in contact with an inner wall of the container and a lower surface thereof is held in contact with a liquid surface of the solder. The mover drive mechanism may further include an outer lid to be mounted on the container to close an opening of the container with the moving member inserted in the storage space. The first opening/closing part is connected to the outer lid to communicate with the non-storage region sandwiched by the outer lid and the moving member. In this case, attaching the outer lid to the container seals the opening of the container, making the non-storage region airtight and allowing the solder to be pushed down efficiently by the mover.

The moving member may further includes a disk member having the lower surface; a tubular member rising from a peripheral edge part of the disk member and having a tubular shape inside the inner wall of the container; and a first projecting part projecting outward from a lower end part of a side surface of the tubular member and to be held in sliding contact with the inner wall of the container. In this case, the first projecting slides against the inner wall of the container to supply solder efficiently.

A second projecting part may be further provided that projects outward from an upper end part of the side surface of the tubular member and to be held in sliding contact with the inner wall of the container. By providing two sliding contact points in the vertical direction, the efficiency of solder supply is further enhanced. However, the presence of two separate upper and lower projecting parts makes it difficult for the moving member to move in the vertical direction. Therefore, considering this point, it is suitable to provide cut parts in the first and second projecting parts. In other words, the cut parts serve as an escape route for air, enabling the moving member to move stably in the vertical direction.

The storage pot may include a concave-shaped container having an inside functioning as the storage space while being open upward, the storage pot being provided with the discharge port in the bottom part. The mover may include a moving member movable in the vertical direction while a side surface is facing and separated from an inner wall of the container by a minute distance and a lower surface is held in contact with a liquid surface of the solder. The mover drive mechanism may further include an outer lid to be mounted on the container to close an opening of the container with the moving member inserted in the storage space. The first opening/closing part may be connected to the outer lid to communicate with the non-storage region sandwiched by the outer lid and the moving member. In this case, part of the compressed air is fed to between the container inner wall of the storage pot and the solder under pressure via the minute gap formed between the container inner wall and the moving member. As a result, the amount of the solder remaining on the container inner wall of the storage pot can be reduced.

The outer lid may be attachable to and detachable from the container. In this case, when the solder is used up, the moving member can be removed from the storage space by removing the outer lid. The moving member may include an upper surface facing the non-storage region and a projecting member projecting from a central part of the upper surface toward the opening of the container. The projecting member facilitates the work of placing and taking out the moving member on the inner lid.

The mover drive mechanism may include a second opening/closing part for switching suction and suction stop of the air from the non-storage region and configured to pull up the mover by sucking the air from the non-storage region by way of the second opening/closing part. The controller may be configured to control the mover drive mechanism to suck the solder from the discharge port by the mover being pulled up due to a pressure drop in the non-storage region. For example, pulling in solder from the discharge port can be performed by the piston retraction of the pressing cylinder in the conventional device, but the same problem as with solder discharge occurs. In contrast, when solder is sucked into the discharge port by a pressure reduction in the non-storage region, a pressing cylinder is not necessary, and, as with solder discharge, this greatly contributes to downsizing the solder supply device in the vertical direction.

The controller may be configured to control the mover drive mechanism to switch the first and second opening/closing parts respectively to pressure feed and suction stop when the solder is supplied, and switch the first and second opening/closing parts respectively to pressure feed stop and suction while the supply of the sold is stopped. By controlling the first and second open/close parts in this manner, solder discharge and solder retraction can be smoothly switched.

The mover drive mechanism may include a pressure feeder configured to feed the air under pressure; a sucker configured to suck the air; and a flow passage switching valve. The flow passage switching valve may include a first port to be connected to the non-storage region, a second port to be connected to the pressure feeder and a third port to be connected to the sucker. The flow passage switching valve may function as the first opening/closing part by connecting and disconnecting the second port to and from the first port and functioning as the second opening/closing part by connecting and disconnecting the third port to and from the first port. The use of a single flow path switching valve in this way simplifies the structure of the mover drive mechanism.

A cutter mechanism may be further provided to cut the solder hanging down from the discharge port at a position right below the discharge port, thereby effectively preventing excess solder from dripping at times other than when solder is discharged.

The cutter mechanism may include a cutter configured to cut the solder hanging down from the discharge port and a solder collector configured to receive and collect the solder dropping down by being cut by the cutter. In the cutter mechanism, solder cut by the cutter can be reliably collected in the solder collector. As a result, the solder piece can be reliably prevented from scattering around the apparatus.

A pot holder may be provided to hold a plurality of the storage pots side by side in a horizontal direction, the controller may be configured to select one of the plurality of storage pots as a selected pot and control the mover drive mechanism to discharge the solder from the discharge port of the selected pot by pushing down the mover in the storage space of the selected pot. In this case, even if the selected pot becomes empty, solder dispensing can be performed continuously by selecting another storage pot. As a result, solder supply can be performed over a long period of time.

A remaining amount detector may be provided to detect a remaining amount of the solder of each storage pot, and the controller may be configured to select the selected pot from the storage pots not selected as the selected pot and control the mover drive mechanism to discharge the solder from the discharge port of the selected pot by pushing down the mover in the storage space of the newly selected pot if it is detected by the remaining amount detector that the solder remaining in the selected pot has fallen below a set value set in advance. Therefore, the solder contained in the storage pot can be consumed efficiently and running costs can be reduced.

As described above, according to the disclosure, solder can be efficiently supplied while an apparatus size is reduced in a vertical direction.

### BRIEF DESCRIPTION OF THE DRAWINGS

FIG. 1 is a diagram showing a printing apparatus equipped with a first embodiment of a solder supply device according to the disclosure.

FIG. 2 is a perspective view showing the configuration of the solder supply mechanism corresponding to the first embodiment of the solder supply device according to the disclosure.

FIG. 3 is a view showing a storage pot to be mounted into the solder supply mechanism of FIG. 2 and an adapter and an outer lid to be attached to the storage pot.

FIG. 4 is a diagram showing the solder supply mechanism and constituent elements to be connected to the solder supply mechanism.

FIG. 5 is a diagram schematically showing the configuration and operation of a cutter mechanism for cutting the solder.

FIG. 6A shows an air circuit diagram when the solder is discharged from the first suppliable pot by giving a positive pressure to the first suppliable pot.

FIG. 6B shows an air circuit diagram when the solder is sucked into the first suppliable pot by giving a negative pressure to the first suppliable pot.

FIG. 6C shows an air circuit diagram when the solder is discharged from the second suppliable pot by giving a positive pressure to the second suppliable pot.

FIG. 6D shows an air circuit diagram when the solder is sucked into the second suppliable pot by giving a negative pressure to the second suppliable pot.

FIG. 7 is a flow chart showing an operation of the solder supply mechanism to supply the solder using the two suppliable pots.

FIG. 8 is a flow chart showing a mounting procedure of the suppliable pot into the solder supply mechanism by the operator.

FIG. 9 is a diagram schematically showing a solder discharging operation, a solder sucking operation and a solder cutting operation.

FIG. 10 is a flow chart showing the use-up process.

FIG. 11 is a diagram showing a storage pot and an adapter and an outer lid to be attached to the storage pot in a second embodiment of the solder supply device according to the disclosure;

FIG. 12 is a diagram schematically showing a solder discharging operation, a solder sucking operation and a solder cutting operation in the second embodiment; and

FIG. 13 is a diagram schematically showing a solder discharging operation in a third embodiment of the solder supply device according to the disclosure.

### DETAILED DESCRIPTION

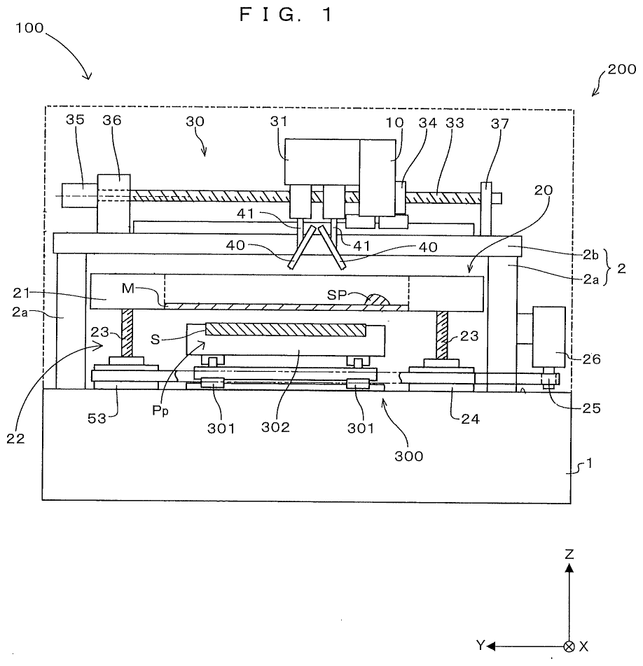

FIG. 1 is a diagram showing a printing apparatus equipped with a first embodiment of a solder supply device according to the disclosure. In FIG. 1 and subsequent figures, XYZ orthogonal coordinate axes are shown as appropriate to show a positional relationship of respective components of the apparatus. Further, if necessary, an arrow direction of each coordinate axis is treated as a positive side and an opposite arrow direction of each coordinate axis is treated as a negative side.

A printing apparatus 100 is provided with a base 1 having a substantially rectangular parallelepiped shape and a support mechanism composed of two support frames 2, 2 mounted on the upper surface of the base 1. Each of these support frames 2, 2 is a gate-shaped frame in which a beam member 2b extending in a Y-axis direction is bridged between column members 2a, 2a provided on both end parts in the Y-axis direction of the base 1. Out of these two support frames 2, 2, one support frame 2 is arranged in a central part in an X-axis direction of the base 2, and the other support frame 2 is arranged on an end part in a positive X-axis direction of the base 1. A printing unit 200 is supported on the upper surface of the base 1 between the two support frames 2, 2 arranged in the Y-axis direction. On the other hand, a substrate conveyance unit 300 extends in the X-axis direction through the gate-shaped support frames 2, 2 and is supported on the upper surface of the base 1.

The substrate conveyance unit 300 is arranged between a loading conveyor and an unloading conveyor provided apart from each other in the X-axis direction, receives a substrate S loaded from the loading conveyor and conveys the substrate S toward the unloading conveyor. Further, the substrate conveyance unit 300 has a function of appropriately stopping the substrate S at a standby position and a printing position Pp provided between the loading conveyor and the unloading conveyor. Specifically, the substrate conveyance unit 300 is configured such that a substrate table 302 is supported on upper parts of two slide mechanisms 301, 301 extending in the X-axis direction. This substrate table 302 moves in the X-axis direction while holding the substrate S on the upper surface thereof, thereby causing the substrate S received from the loading conveyor to wait at the standby position before the printing unit 200, conveying the substrate S to the printing position Pp in the printing unit 200 and unloading the substrate S printed at the printing position Pp to the unloading conveyor. The printing unit 200 prints the substrate S conveyed to the printing position Pp.

The printing unit 200 is provided with a solder supply mechanism 10, a mask elevation mechanism 20 for raising and lowering a mask M above the substrate conveyance unit 300 and a printing mechanism 30 for printing solder supplied to the mask M on the substrate S. The solder supply mechanism 10 has a function of supplying the solder to the mask M and corresponds to the first embodiment of the solder supply device according to the disclosure. Note that the configuration and operation of the solder supply mechanism 10 are described in detail later.

The mask elevation mechanism 20 is arranged between the aforementioned support frames 2 and 2 arranged in the Y-axis direction on the upper surface of the base 1 and has a schematic configuration for raising and lowering the mask M by rising and lowering a mask holding frame 21 holding the mask M by a frame driver 22. This frame driver 22 raises and lowers the mask holding frame 21 by rotating pulleys 24 respectively threadably engaged with four ball screw shafts 23 extending downward (negative Z-axis direction) from the mask holding frame 21 via a belt 25 by a servo motor 26.

In printing on the substrate S, the mask elevation mechanism 20 lowers the mask M. In this way, the lower surface of the mask M is overlapped on the upper surface of the substrate S conveyed to and fixed at the printing position Pp below the mask M held by the mask holding frame 21. On the other hand, after printing on the substrate S, the mask elevation mechanism 20 raises the mask M to separate the lower surface of the mask M from the upper surface of the substrate S (state of FIG. 1).

The printing mechanism 30 is supported by the beam members 2b, 2b of the support frames 2, 2 above the mask elevation mechanism 20. The printing mechanism 30 prints the solder on the substrate S via pattern holes formed in the mask M by sliding squeegees 40 in the Y-axis direction on the upper surface of the mask M, to which the solder was supplied. In this embodiment, the printing mechanism 30 includes the squeegee 40 (right squeegee in FIG. 1) for sliding on the mask M in a positive Y-axis direction and the squeegee 40 (right squeegee in FIG. 1) for sliding on the mask M in a negative Y-axis direction.

The printing mechanism 30 includes a printing pressure applier 31 for holding each of these squeegees 40 via rods 41 expandable in the vertical direction. This printing pressure applier 31 presses the upper surface of the mask M with a predetermined printing pressure by lowering the squeegee 40 corresponding to a sliding direction, out of the two squeegees 40, 40, at the time of printing. Further, the solder supply mechanism 10 is attached to the printing pressure applier 31. The printing pressure applier 31 and the solder supply mechanism 10 are integrally movable in the Y-axis direction by a ball screw mechanism. Specifically, a nut member 34 threadably engaged with a ball screw shaft 33 extending in the Y-axis direction is attached to the solder supply mechanism 10. If the ball screw shaft 33 is rotated by a servo motor 35, the printing pressure applier 31 and the solder supply mechanism 10 moves in the Y-axis direction. Therefore, a predetermined amount of solder SP is supplied to the upper surface of the mask M by operating the solder supply mechanism 10. Note that the solder supply mechanism 10 corresponds to the first embodiment of the solder supply device according to the disclosure and the configuration and operation thereof are described in detail later.

By operating the servo motor 35 while the squeegee 40 is pressed against the upper surface of the mask M with the paste-like solder SP (cream solder) present on the upper surface of the mask M, the squeegee 400 slides in the Y-axis direction on the upper surface of the mask M and the solder is printed on the substrate S. Note that both axial end parts of the ball screw shaft 33 are rotatably supported on fixing members 36, 37 mounted on both end parts in the Y-axis direction of the upper surface of the beam member 2b, and the servo motor 35 is fixed to the fixing member 36.

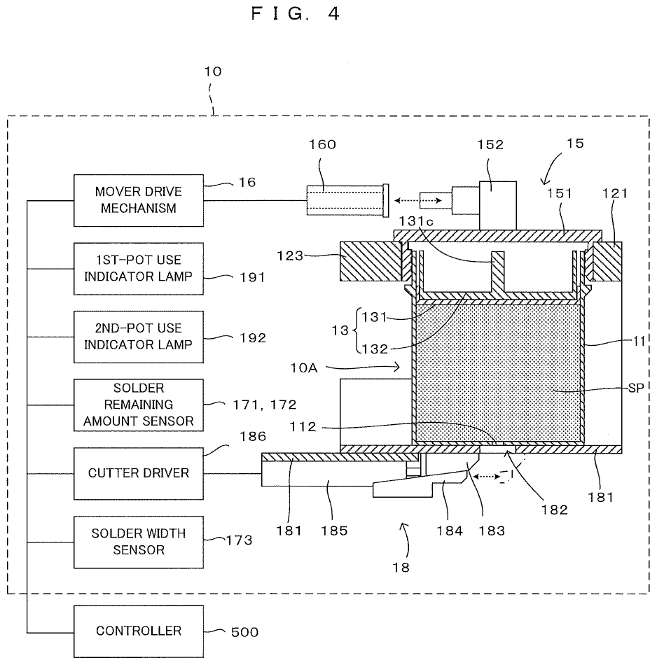

Each component of the printing apparatus 100 thus configured is controlled by a controller (500 in FIG. 4) configured similarly to a general computer. The controller is, for example, provided with a CPU for performing various arithmetic processings, a ROM, which is a read-only memory for storing a basic program, a RAM, which is a readable and writable memory for storing various pieces of information, a magnetic disk for storing control software, data and the like. In the controller, the CPU serving as a main controller performs an arithmetic processing in accordance with a procedure described in the program to control each component of the printing apparatus 100. Of course, the solder supply mechanism 10 configured as described next is also controlled by the controller.

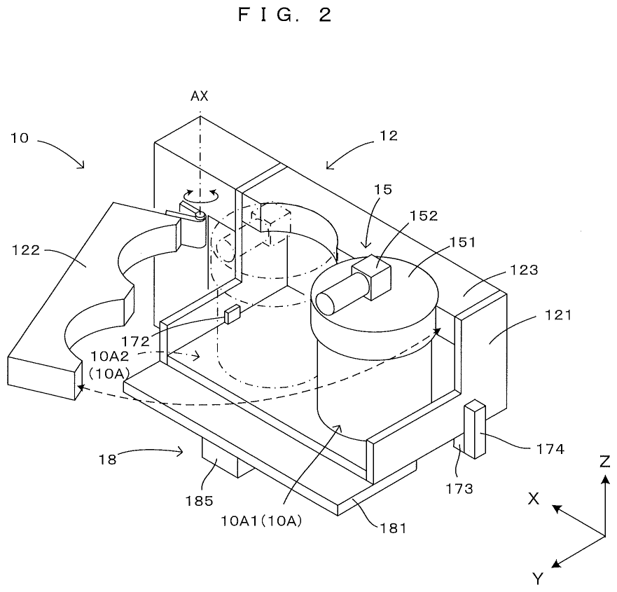

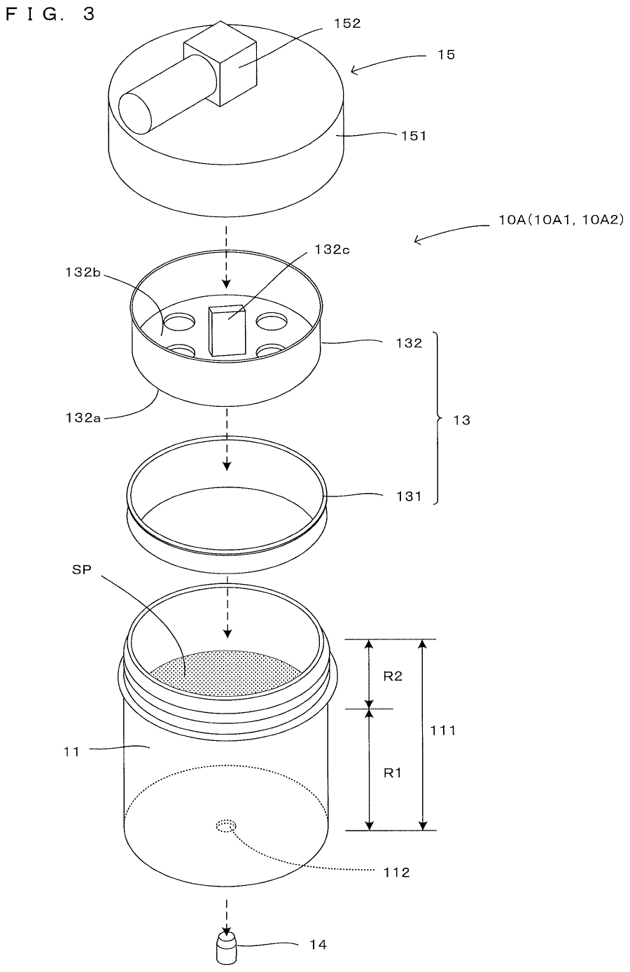

FIG. 2 is a perspective view showing the configuration of the solder supply mechanism corresponding to the first embodiment of the solder supply device according to the disclosure. FIG. 3 is a view showing a storage pot to be mounted into the solder supply mechanism of FIG. 2 and an adapter and an outer lid to be attached to the storage pot. FIG. 4 is a diagram showing the solder supply mechanism and constituent elements to be connected to the solder supply mechanism. The solder supply mechanism 10 is for pushing out solder SP in the storage pot 11 by an air pressure and supplying the solder SP to the upper surface of the mask M while holding the storage pot 11 storing the solder SP by a pot holder 12.

As shown in FIG. 3, the storage pot 11 includes a concave-shaped container open upward (hollow cylindrical cup shape in this embodiment) and an internal space of the container functions as a storage space 111 for storing the solder SP. Further, a discharge port 112 is provided to communicate with the storage space 111 in a bottom part of the storage pot 11, and the solder SP can be discharged downward from the discharge port 112. When the storage pot 11 is provided for the printing apparatus 100, an inner lid 131 is inserted to cover the solder SP stored in the storage space 111 from above, whereas a plug member 14 is mounted in the discharge port 112. In the first embodiment, the inner lid 131 is used as a part of a “mover” of the disclosure at the time of supplying the solder, whereas the plug member 14 is removed from the storage pot 11 after the storage pot 11 is mounted into the pot holder 12.

The inner lid 131 is movable in a vertical direction Z while the side surface thereof slides in contact with the inner wall of the storage pot 11 and the lower surface thereof is held in contact with a liquid surface of the solder SP. Further, an adapter 132 is loosely inserted in the storage space 111 of the storage pot 11. The adapter 132 includes a lower surface 132a to be held in contact with the upper surface of the inner lid 131, an upper surface 132b facing upward and a projecting member 132c projecting from a central part of the upper surface 132b toward an opening of the container (hereinafter, referred to as a “container opening”) as shown in FIG. 3. By providing the projecting member 132c, operator's placing operation of placing the adapter 132 on the upper surface of the inner lid 131 and take-out operation of the adapter 132 are facilitated.

The adapter 132 is movable in the vertical direction integrally with the inner lid 132 while being placed on the upper surface of the inner lid 131. That is, the adapter 132 is an example of a “moving member” of the disclosure and functions as the “mover” of the disclosure in cooperation with the inner lid 131.

Further, a mover 13 constituted by the inner lid 131 and the adapter 132 also functions to partition the storage space 111 into two regions. That is, the storage space 111 is partitioned into a storage region R1 below the mover 13 for storing the solder SP and a non-storage region R2 above the mover 13.

An outer lid 15 is mounted to close an opening of the storage pot 11 having the adapter 132 added in this storage space 111 in this way before the storage pot 11 is mounted into the pot holder 12 (see FIG. 3). In the outer lid 15, an internal thread (see an enlarged view in FIG. 13) is formed inside a lid body 151 and threadably engaged with an external thread (see the enlarged view in FIG. 13) provided on an upper end part of the storage pot 11 by rotating the outer lid 15 in a predetermined direction, whereby the outer lid 15 can be mounted and the storage space 111 can be sealed. That is, the airtightness of the non-storage region R2 is enhanced by mounting the outer lid 15. Conversely, by rotating the outer lid 15 in an opposite direction, the outer lid 15 can be removed from the storage pot 11.

A port 152 is mounted on the ceiling surface of the lid body 151. This port 152 communicates with the non-storage region R2 of the storage space 111. By attaching a one-touch coupler 160 to this port 152 as shown in FIG. 4, the non-storage region R2 is connected to a mover drive mechanism 16 via this one-touch coupler 160. Thus, the mover 13 moves in the vertical direction Z by controlling an internal pressure of the non-storage region R2 by the mover drive mechanism 16. By this movement, the solder SP is discharged and sucked. Note that the configuration of the mover drive mechanism 16, a discharging operation of the solder SP and a sucking operation of the solder SP are described in detail later.

As shown in FIG. 3, the plug member 14 is removed at a suitable timing after the adapter 132 is additionally inserted into the storage space 111 and the outer lid 15 is mounted. The storage pot 11 capable of discharging the solder SP in this way is appropriately referred to as a “suppliable pot 10A” in this specification to be distinguished from a purchased storage pot.

To hold the suppliable pot 10A, the pot holder 12 is provided. The pot holder 12 includes a holder body 121 in which two suppliable pots 10A can be placed side by side in a horizontal direction, and a door body 122 supported rotatably about an axis of rotation AX extending in the vertical direction Z with respect to the holder body 121. The holder body 121 includes a support member 123 for supporting the outer lids 15 of the suppliable pots 10A from a back surface side. This support member 123 includes two arcuately cut parts engageable with outer side parts of the outer lids 15 in a plan view from above. Further, the door body 122 is also provided with similar cut parts. Thus, as shown in FIG. 2, when the door body 122 is separated from the support member 123, the suppliable pots 10A can be mounted into the holder body 121 and the suppliable pot 10A empty with the solder SP (hereinafter, appropriately referred to as an “empty pot”) can be taken out from the holder body 121.

On the other hand, if the door body 122 is integrated with the support member 123 with both of the two suppliable pots 10A placed in the holder body 121, the suppliable pots 10A are sandwiched by the door body 122 and the support member 123 as shown in FIG. 4. In this way, the two suppliable pots 10A are firmly held in the solder supply mechanism 10. Note that, for the convenience of the following description, the suppliable pot 10A or the empty pot on a right side when viewed from the side of the door body 122, i.e. from a (+)Y direction are respectively called a “first suppliable pot 10A1” and a “first empty pot” as shown in FIG. 2. On the other hand, the suppliable pot 10A or the empty pot on a left side when viewed from the side of the door body 122 are respectively called a “second suppliable pot 10A2” and a “second empty pot”.

The remaining amount of the solder SP in the suppliable pot 10A1, 10A2 decreases as the solder is discharged. Accordingly, solder remaining amount sensors 171, 172 are respectively provided near the lower ends of the respective suppliable pots 10A1, 10A2 and detect the amounts of the solder remaining in the storage spaces 111. In this way, the solder remaining amount sensors 171, 172 correspond to examples of a “remaining amount detector” of the disclosure. Note that only the solder remaining amount sensor 172 is shown in FIG. 2. In this embodiment, the solder remaining amount sensors 171, 172 are of an electrostatic capacitance type. Further, to detect a width of the solder SP discharged from each suppliable pot 10A1, 10A2, a solder width sensor 173 is fixedly arranged on the holder body 121 via a sensor mounting member 174 as shown in FIG. 2.

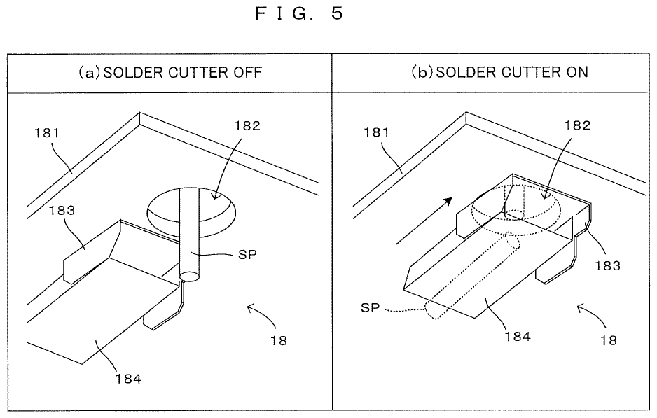

FIG. 5 is a diagram schematically showing the configuration and operation of a cutter mechanism for cutting the solder. The configuration and operation of a cutter mechanism 18 are described below with reference to FIGS. 2, 4 and 5. The cutter mechanism 18 has a function of removing and collecting a tip part of the solder SP, which could not be sucked into the discharge port 122 by a sucking operation to be described later. As shown in FIGS. 2, 4 and 5, the cutter mechanism 18 includes a cutter support 181 fixed to the lower surface of the holder 121. This cutter support 181 is provided with two through holes 182, 182 corresponding to two discharge ports 112. Note that only the through hole 182 provided to correspond to the discharge port 112 of the first suppliable pot 10A1 is shown in FIGS. 4 and 5.

A cutter 183 is provided to freely enter and retract from a space right below the through hole 182 (hereinafter, referred to as a “cutting space”) at a position right below the cutter support 181. Further, a box-shaped solder collector 184 is attached obliquely below the cutter 183, and horizontally movable integrally with the cutter 183. Further, a piston of an air cylinder 185 is connected to the rear end of the cutter 183. This air cylinder 185 is connected to a cutter driver 186 as shown in FIG. 4. This cutter driver 186 feeds compressed air to the air cylinder 185 in response to a drive command from the controller 500 of the printing apparatus 100 and drives the piston of the air cylinder 185. For example, if the cutter driver 186 contracts the piston of the air cylinder 185, the cutter 183 and the solder collector 184 are retracted toward the air cylinder 185 from the cutting space as shown in field (a) of FIG. 5 and FIG. 4. In this state, the solder SP is discharged from the discharge port 112 and supplied to the upper surface of the mask M. On the other hand, if the cutter driver 186 extends the piston of the air cylinder 185, the solder SP present in the cutting space is cut by a tip part of the cutter 183, i.e. a blade part, and collected into the solder collector 184 moved to the cutting space slightly later than the blade part as shown in field (b) of FIG. 5. Note that, in this embodiment, the controller 500 cuts the solder SP hanging down into the cutting space by repeating minute forward and backward movements at a timing at which the blade part moves to the cutting space. Thus, the solder SP can be reliably cut. Further, if this cutting operation is completed, the cutter 183 stops in a state closing the through hole 182. In this way, even if the solder SP inadvertently hangs down from the discharge port 112, the solder SP can be effectively prevented from falling down on the mask M.

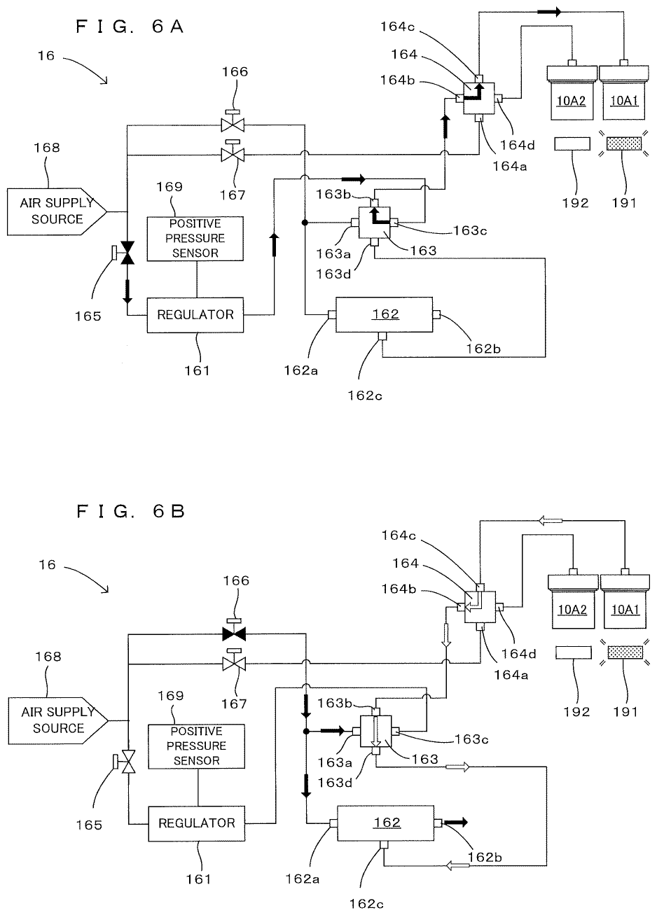

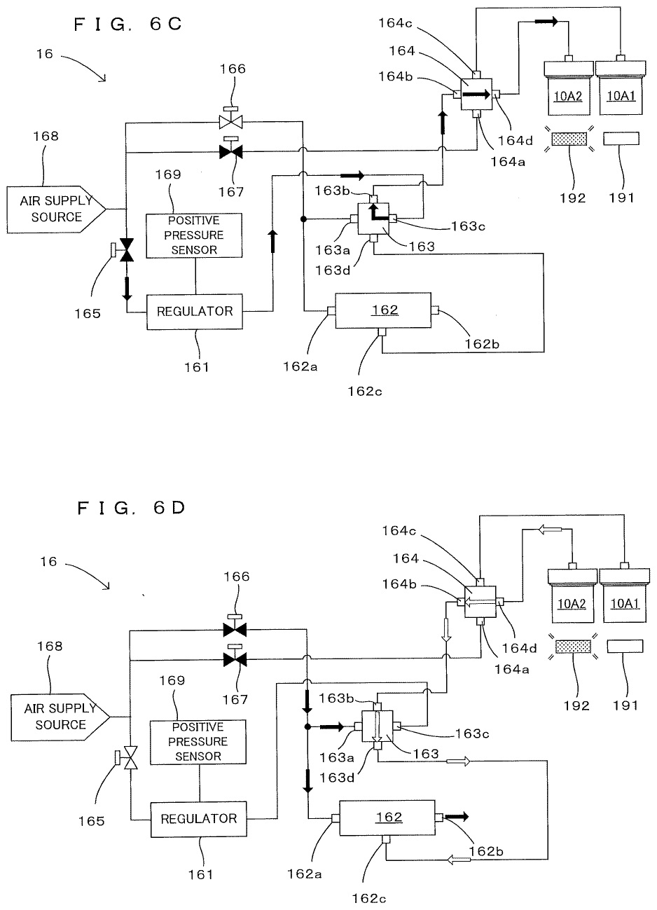

Next, the configuration and operation of the mover drive mechanism 16 are described with reference to FIGS. 6A to 6D. FIGS. 6A to 6D are diagrams showing the configuration and operation of the mover drive mechanism. FIG. 6A shows an air circuit diagram when the solder SP is discharged from the first suppliable pot 10A1 by giving a positive pressure to the first suppliable pot 10A1. FIG. 6B shows an air circuit diagram when the solder SP is sucked into the first suppliable pot 10A1 by giving a negative pressure to the first suppliable pot 10A1. FIG. 6C shows an air circuit diagram when the solder SP is discharged from the second suppliable pot 10A2 by giving a positive pressure to the second suppliable pot 10A2. FIG. 6D shows an air circuit diagram when the solder SP is sucked into the second suppliable pot 10A2 by giving a negative pressure to the second suppliable pot 10A2. Note that black arrows and white arrows in these figures respectively represent a positive pressure and a negative pressure. Further, in symbols representing valves in FIGS. 6A to 6D, a black triangular part indicates a state where the valve is open and a white triangular part indicates a state where the valve is closed. Further, 191, 192 in FIGS. 6A to 6D denote indicator lamps attached to the pot holder 12, and the indicator lamp 191 is turned on during the use of the first suppliable pot 10A1, whereas the indicator lamp 192 is turned on during the use of the second suppliable pot 10A2.

The mover drive mechanism 16 includes a regulator 161 functioning as a pressure feeder for feeding air under pressure while appropriately changing the magnitude of a pressure in feeding compressed air under pressure to each suppliable pot 10A1, 10A2, i.e. a positive pressure, a vacuum ejector 162 functioning as a sucker for generating a negative pressure for sucking air from each suppliable pot 10A1, 10A2, an air operate valve 163 for switching a positive pressure and a negative pressure and an air operate valve 164 for switching supply destinations of the positive pressure and the negative pressure. Further, three control valves 165 to 167 are provided to selectively switch the following four operating states:
(a) an operation of discharging the solder SP in the first suppliable pot 10A1,
(b) an operation of sucking the solder SP into the first suppliable pot 10A1,
(c) an operation of discharging the solder SP in the second suppliable pot 10A2, and
(d) an operation of sucking the solder SP into the second suppliable pot 10A2.

The regulator 161 is connected to a compressed air supply source 168 via the control valve 165. A utility facility or the like of a factory where the printing apparatus 100 is installed can be, for example, used as the compressed air supply source 168. If the control valve 165 is turned on in response to an opening command from the controller 500, compressed air is given to the regulator 161 and the positive pressure is regulated to be suitable for solder discharge. Therefore, in this embodiment, the control valve 165 functions as a solder discharge valve. Note that a positive pressure sensor 169 is connected to the regulator 161 to monitor the pressure at this time.

The vacuum ejector 162 includes a supply port 162a, an exhaust port 162b and a vacuum port 162c and functions as an example of a “sucker” of the disclosure. The supply port 162a is connected to the compressed air supply source 168 via the control valve 166. Thus, if the control valve 166 is turned on in response to an opening command from the controller 500, compressed air is given to the supply port 162a, flows inside the ejector and flows out from the exhaust port 162b. At this time, in the vacuum port 162c, a suction force is generated. A negative pressure is given to each suppliable pot 10A1, 10A2 using this suction force. On the other hand, if the control valve 166 is turned off in response to a closing command from the controller 500, suction by the vacuum ejector 162 is stopped. Therefore, the control valve 166 functions as a solder suction valve and suction and suction stop by the air operate valve 163 can be switched. However, in this embodiment, the control valve 166 also functions as a switching valve for switching a positive pressure and a negative pressure in cooperation with the air operate valve 163.

The air operate valve 163 includes four ports 163a to 163d. The port 163a is connected to the control valve 166. The port 163b is connected to the non-storage regions R2 of the suppliable pots 10A1, 10A2 via the other air operate valve 164 and the outer lid 15. The remaining two ports 163c, 163d are respectively connected to an output of the regulator 161 and the vacuum port 162c of the vacuum ejector 162. Out of these, the ports 163b to 163d respectively correspond to a “first port”, a “second port” and a “third port” of the disclosure.

The air operate valve 163 includes a positive pressure supply flow passage connecting the ports 163b, 163c and a negative pressure supply flow passage connecting the ports 163b, 163d. The air operate valve 163 opens the negative pressure supply flow passage and blocks the positive pressure supply flow passage when a pressure received by the port 163a exceeds a threshold value, and opens the positive pressure supply flow passage and blocks the negative pressure supply flow passage when the pressure falls to or below the threshold value. That is, the air operate valve 163 functions as a first opening/closing part for controlling connection and disconnection of the ports 163b, 163c and functions as a second opening/closing part for controlling connection and disconnection of the ports 163b, 163d. Therefore, if the control valve 166 is turned on, the vacuum ejector 162 can operate to generate a negative pressure and this negative pressure can be given to the suppliable pots 10A1, 10A2 along the negative pressure supply flow passage as described above. Conversely, if the control valve 166 is turned off, the positive pressure can be given to the suppliable pots 10A1, 10A2 along the positive pressure supply flow passage. As just described, in this embodiment, the air operate valve 163 functions as an example of a “flow passage switching valve” of the disclosure.

The port 163b of the air operate valve 163 is connected to a port 164b of the air operate valve 164. This air operate valve 164 includes, besides the port 164b, a port 164a connected to the control valve 167, a port 164c connected to the first suppliable pot 10A1 and a port 164d connected to the second suppliable pot 10A2. This air operate valve 164 includes a first pot flow passage connecting the ports 164b, 164c and a second pot flow passage connecting the ports 164b, 164d. The air operate valve 164 is configured to open the first pot flow passage when a pressure received by the port 164a exceeds a threshold value and, on the other hand, open the second pot flow passage when the pressure falls to or below the threshold value. Therefore, if the control valve 167 is turned on, a positive pressure or negative pressure is given to the first suppliable pot 10A1 via the first pot flow passage. Conversely, if the control valve 167 is turned off, a positive pressure or negative pressure is given to the second suppliable pot 10A2 via the second pot flow passage. In this way, the control valve 167 functions as a pot switching valve.

In the mover drive mechanism 16 thus configured, operating states are switched as shown in Table 1 by ON/OFF state combinations of the control valves 165 to 167 described below.

TABLE 1

| | | | ACTIVE STATE | | CORRESPONDING |
|---|---|---|---|---|---|
| VALVE165 | VALVE166 | VALVE167 | POT10A1 | POT10A2 | DRAWING |
| ON | OFF | OFF | DISCHARGE | | FIG. 6A |
| OFF | ON | OFF | SUCTION | | FIG. 6B |
| ON | OFF | ON | | DISCHARGE | FIG. 6C |
| OFF | ON | ON | | SUCTION | FIG. 6D |

In this embodiment, the ON/OFF states of the control valves 165 to 167 are switched in accordance with the program of the controller 500 of the printing apparatus 100, but a controller for the above switch may be provided in the solder supply mechanism 10 corresponding to the solder supply device according to the disclosure.

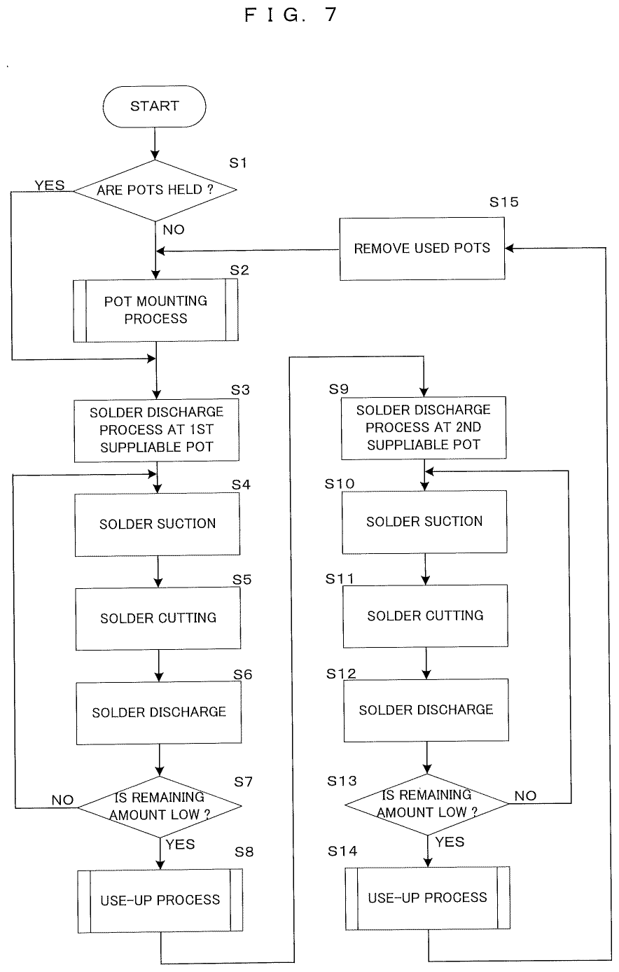

Next, an operation of supplying the solder SP by the solder supply mechanism 10 is described with reference to FIGS. 7 to 10. FIG. 7 is a flow chart showing an operation of the solder supply mechanism to supply the solder using the two suppliable pots. At a suitable timing such as when the printing apparatus 100 is powered on or when maintenance is completed, the controller 500 determines whether or not both the first and second suppliable pots 10A1, 10A2 are held in the pot holder 12 (Step S1). This determination can be made, for example, by the solder remaining amount sensors 171, 172.

The controller 500 skips Step S2 and proceeds to Step S3 if “YES” is determined in Step S1. On the other hand, if at least one of the first and second suppliable pots 10A1, 10A2 is not mounted in the pot holder 12, the controller 500 determines “NO” in Step S1 and notifies it to an operator by displaying a message urging the mounting of the first and/or second suppliable pot(s) 10A1, 10A2 on a display (not shown) of the printing apparatus 100. Then, a pot mounting process (Step S2) is performed by the operator. If it is confirmed that this pot mounting process is performed and both the first and second suppliable pots 10A1, 10A2 are held in the pot holder 12, the controller 500 proceeds to next Step S3.

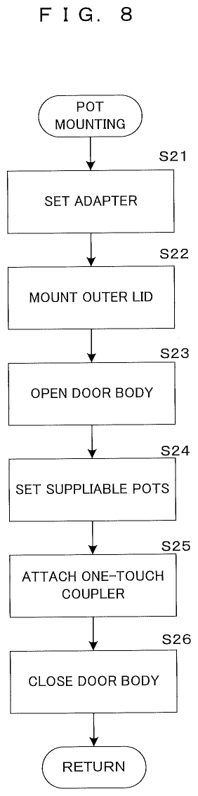

FIG. 8 is a flow chart showing a mounting procedure of the suppliable pot into the solder supply mechanism by the operator. The storage pot 11 is provided with the solder SP stored in the storage space 111 covered by the inner lid 131 and the plug member 14 inserted in the discharge port 112. In this embodiment, the solder is supplied utilizing the inner lid 131. Therefore, the operator sets the adapter 132 on the inner lid 131 (Step S21) with the inner lid 131 remaining. Subsequent to that, the operator mounts the outer lid 15 to close the opening of the storage pot 11 (Step S22). In this way, the preparation of the suppliable pot 10A is completed.

Subsequently, the operator rotates the door body 122 about the axis of rotation AX to open the door body 122 as shown in FIG. 2 (Step S23). In this way, a pot placement space is opened and the operator sets the two suppliable pots 10A side by side in the horizontal direction in the open placement space (Step S24). Then, the operator attaches the one-touch coupler 160 to the port 152 of each suppliable pot 10A (Step S25). In this way, the first and second suppliable pots 10A1, 10A2 are connected to the mover drive mechanism 16. Thereafter, the operator removes the plug members 14 from the discharge ports 112 of the first and second suppliable pots 10A1, 10A2 and rotates the door body 122 about the axis of rotation AX in the opposite direction to close the door body 122 as shown in FIG. 4 (Step S26). In this way, the mounting of the two suppliable pots 10A1, 10A2 is completed.

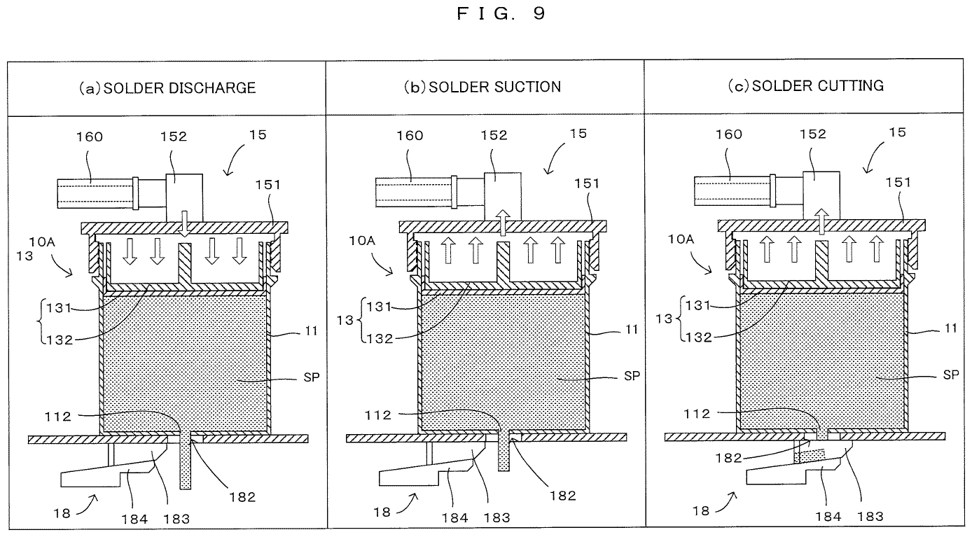

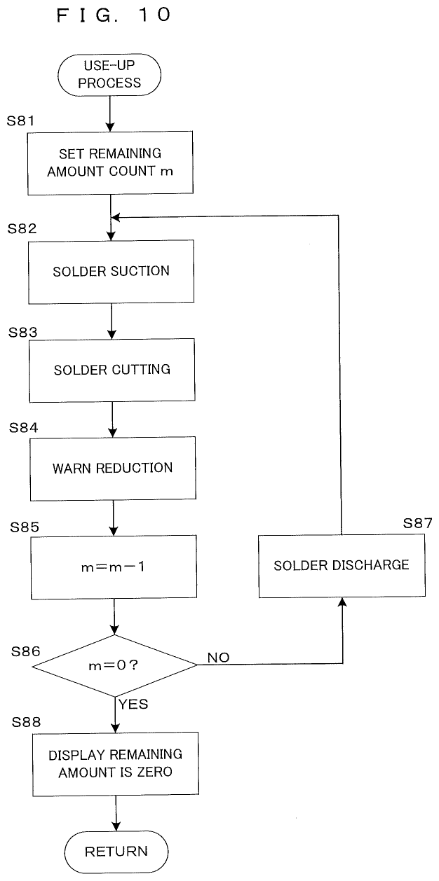

Referring back to FIG. 7, description is continued with reference to FIG. 9. FIG. 9 is a diagram schematically showing a solder discharging operation, a solder sucking operation and a solder cutting operation. If a solder discharge command is given to the mover drive mechanism 16 from the controller 500 after the preparation of the two suppliable pots 10A1, 10A2 filled with the solder SP is completed as described above, the first suppliable pot 10A1 is first selected as a “selected pot” of the disclosure. Then, an amount of the solder SP corresponding to the solder discharge command is discharged from the first suppliable pot 10A1 (solder discharge process: Step S3). That is, the mover drive mechanism 16 sets the valves 165 to 167 respectively to “ON”, “OFF” and “OFF” as shown in FIG. 6A. Then, as shown in field (a) of FIG. 9, compressed air is given to the first suppliable pot 10A1 and a pressure in the non-storage region R2 is increased to a value exceeding an atmospheric pressure. In this way, the mover 13 (=adapter 132+inner lid 131) moves downward, and an amount of the solder SP corresponding to the pressure regulated by the regulator 161 is pushed out downward from the discharge port 112. By this solder discharge process, the solder SP is supplied to the upper surface of the mask M.

After the completion of solder supply, the mover drive mechanism 16 sets the valves 165 to 167 respectively to “OFF”, “ON” and “OFF” as shown in FIG. 6B. Then, as shown in field (b) of FIG. 9, a negative pressure is given to the first suppliable pot 10A1, i.e. the air in the non-storage region R2 is sucked. In this way, the pressure in the non-storage region R2 is reduced to a value lower than the atmospheric pressure and the mover 13 (=adapter 132+inner lid 131) moves upward. According to that movement, the solder SP hanging down from the discharge port 112 is sucked toward the storage space 111 (solder suction process: Step S4).

Subsequent to that, the cutter driver 186 having received a cutting command from the controller 500 operates such that the tip part (blade part) of the cutter 183 cuts the solder SP hanging down from the discharge port 112 by extending the piston of the air cylinder 185 and the solder collector 184 collects a cut piece of the solder SP while the non-storage region R2 of the first suppliable pot 10A1 is kept decompressed (solder cutting process: Step S5). In this way, the solder SP can be effectively prevented from dripping down from the discharge port 112 from the completion of the supply of the solder SP to the next solder discharge process (Step S6). Further, since the cut solder piece is collected into the solder collector 184, the solder piece can be reliably prevented from scattering around the apparatus.

If the solder discharge command is given to the mover drive mechanism 16 from the controller 500, an amount of the solder SP corresponding to the solder discharge command is discharged from the first suppliable pot 10A1 (solder discharge process: Step S6) as in Step S3. By repeating the solder discharge process in this way, the amount of the solder SP stored in the first suppliable pot 10A1 decreases. Accordingly, in this embodiment, every time solder discharge from the first suppliable pot 10A1 is repeated, the controller 500 determines a remaining amount reduction (Step S7) based on a detection signal from the solder remaining amount sensor 171 arranged near the first suppliable pot 10A1 if the amount of the solder SP remaining in the first suppliable pot 10A1 falls below a set value set in advance. In this embodiment, the above threshold value means such a solder amount that solder discharge can be performed several times (corresponding to a remaining amount count m to be described next).

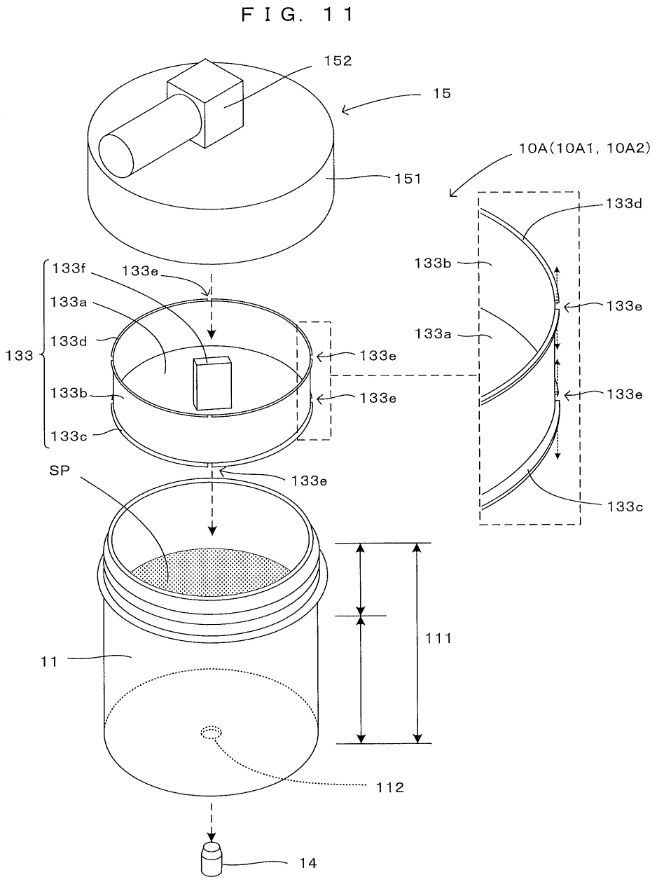

While the remaining amount is equal to or more than the threshold value in Step S7 (“NO” in Step S7), return is made to Step S4 and solder supply is repeated. On the other hand, if the remaining amount falls below the threshold value, i.e. the number of solder supply by the remaining solder SP is several times, the controller 500 performs a use-up process shown in FIG. 10.

FIG. 10 is a flow chart showing the use-up process. The controller 500 efficiently uses the solder P remaining in the first suppliable pot 10A1 without any waste by controlling each component of the solder supply mechanism 10 in accordance with the above program. The controller 500 calculates an executable number of the solder discharge process using the solder SP remaining in the first suppliable pot 10A1 and sets the executable number as the remaining amount count m (Step S81). Then, the controller 500 performs the solder suction process (Step S82) and the solder cutting process (Step S83) and warns a reduction in the solder remaining amount of the first suppliable pot 10A1 to the operator by displaying a corresponding message on the display (not shown) (Step S84) as in Steps S4 to S5 described above.

Subsequently, the controller 500 determines whether or not the remaining amount count m has reached zero (Step S86) after the remaining amount count m is decremented by “1” (Step S85). Here, if the remaining amount count m is a value larger than zero, i.e. if the solder discharge process using the solder SP remaining in the first suppliable pot 10A1 is still executable, the controller 500 returns to Step S82 and repeats the solder suction process (Step S82) and the solder cutting process (Step S83) after performing the solder discharge process (Step S87).

On the other hand, if the remaining amount count m becomes zero, i.e. the first suppliable pot 10A1 becomes empty, the controller 500 warns an operator by displaying a message to the effect that the remaining amount is zero on the display.

Referring back to FIG. 7, description is continued. If it becomes no longer possible to supply the solder from the first suppliable pot 10A1, the controller 500 turns on the indicator lamp 192 while turning off the indicator lamp 191. By switching this lamp indication, it is notified to the operator that the suppliable pot 10A used for solder supply has been switched from the first suppliable pot 10A1 to the second suppliable pot 10A2. Further, the controller 500 starts the supply of the solder SP from the second suppliable pot 10A2.

Solder supply from the second suppliable pot 10A2 is basically the same as that from the first suppliable pot 10A1. That is, in this stage, the first suppliable pot 10A1 is empty, but the solder SP is sufficiently stored in the second suppliable pot 10A2. Accordingly, if a solder discharge command is given to the mover drive mechanism 16 from the controller 500, an amount of the solder SP corresponding to the solder discharge command is discharged from the second suppliable pot 10A2 (solder discharge process: Step S9). That is, the mover drive mechanism 16 sets the valves 165 to 167 respectively to “ON”, “OFF” and “ON” as shown in FIG. 6C. In this way, compressed air is given to the second suppliable pot 10A2, and the pressure in the non-storage region R2 is increased to a value exceeding the atmospheric pressure. As a result, the solder SP is supplied to the upper surface of the mask M as in Step S3.

After the completion of solder supply, the mover drive mechanism 16 sets the valves 165 to 167 respectively to “OFF”, “ON” and “ON” as shown in FIG. 6D. In this way, the pressure in the non-storage region R2 is reduced to a value below the atmospheric pressure and the solder SP hanging down from the discharge port 112 is sucked toward the storage space 111 (solder suction process: Step S10). Subsequent to that, the cutter driver 186 having received a cutting command from the controller 500 causes the piston of the air cylinder 185 to extend while the non-storage region R2 of the second suppliable pot 10A2 is kept decompressed, whereby the tip part (blade part) of the cutter 183 cuts the solder SP hanging down from the discharge port 112 and the solder collector 184 operates to collect the cut piece of the solder SP (solder cutting process: Step S11).

Further, if a solder discharge command is given to the mover drive mechanism 16 from the controller 500, an amount of the solder SP corresponding to the solder discharge command is discharged from the second suppliable pot 10A2 (solder discharge process: Step S12) as in Step S9. By repeating the solder discharge process in this way, the amount of the solder SP stored in the second suppliable pot 10A2 decreases. Accordingly, as in Step S7, every time solder discharge from the second suppliable pot 10A2 is repeated, the controller 500 determines a remaining amount reduction (Step S13) based on a detection signal from the solder remaining amount sensor 172 arranged near the second suppliable pot 10A2 if the amount of the solder SP remaining in the second suppliable pot 10A2 falls below a set value set in advance.

When the remaining amount is equal to or more than the threshold value, return is made to Step S10 and solder supply is repeated. On the other hand, if the remaining amount falls below the threshold value, i.e. the number of solder supply by the remaining solder SP becomes several times, the controller 500 performs the use-up process shown in FIG. 10 (Step S14).

If the second suppliable pot 10A2 also becomes empty as a result of the use-up process (Step S14), solder supply cannot be continued. Accordingly, the controller 500 notifies that effect to the operator by displaying a corresponding message on the display (not shown). Then, as shown in FIG. 7, the controller 500 returns to Step S2 and repeats a series of processes if the operator confirms that the used pots, i.e. the first and second empty pots, have been removed from the pot holder 12 (Step S15).

As described above, according to the first embodiment, the pressure feed and the stop of the pressure feed of air to each suppliable pot 10A1, 10A2 are switched by the air operate valve 163 corresponding to a “first opening/closing part” of the disclosure. By feeding the air by way of the air operate valve 163 under pressure to the non-storage region R2 of the suppliable pot 10A1, 10A2, the mover 13 moves downward and the solder SP is discharged downward from the discharge port 112. In this way, the solder SP is supplied from each suppliable pot 10A1, 10A2, utilizing the compressed air. Therefore, the solder SP can be efficiently supplied while reducing an apparatus size in the vertical direction Z as compared to a conventional apparatus using an extrusion cylinder. This point applies also to solder suction. By pulling up the mover 13 by a pressure reduction in the non-storage region R2, a pressing cylinder used in the conventional apparatus is unnecessary to suck the solder SP from the discharge port 112, and the solder SP hanging down from the discharge port 112 can be efficiently pulled back while the apparatus size is reduced in the vertical direction Z as in the case of solder discharge.

Further, in the first embodiment, the inner lid 131 belonging to the purchased storage pot 11 together with the solder SP is movable in the vertical direction in the storage space 11 with the side surface thereof sliding in contact with the inner wall of the container (hereinafter, referred to as the container inner wall”) of the storage pot 11 and the lower surface thereof held in contact with the liquid surface of the solder SP. Thus, the inner lid 131 can be effectively utilized as the mover 13. Further, as described next, the adhesion of the solder SP to the adapter 132 can be drastically reduced as compared to an embodiment in which the solder SP is pushed down only by an adapter. That is, functions and effects that the adapter 132 is suitably reutilized can be obtained.

Further, the air operate valve 163 also functions as the “first opening/closing part” and the “second opening/closing part” of the disclosure, and switches the negative pressure supply flow passage and the positive pressure supply flow passage. Therefore, the configuration of the mover drive mechanism 16 can be simplified.

Further, since the solder is supplied successively from the two first and second suppliable pots 10A1, 10A2 as shown in FIG. 7, the solder can be supplied over a long period of time.

Furthermore, if a reduction in the remaining amount of the solder SP in the first suppliable pot 10A1 is detected by the solder remaining amount sensor 171, the use-up process (Step S8) shown in FIG. 10 is performed. Further, if a reduction in the remaining amount of the solder SP in the second suppliable pot 10A2 is detected by the solder remaining amount sensor 172, the use-up process (Step S8) is similarly performed. Thus, the solder SP stored in each suppliable pot 10A1, 10A2 can be efficiently consumed.

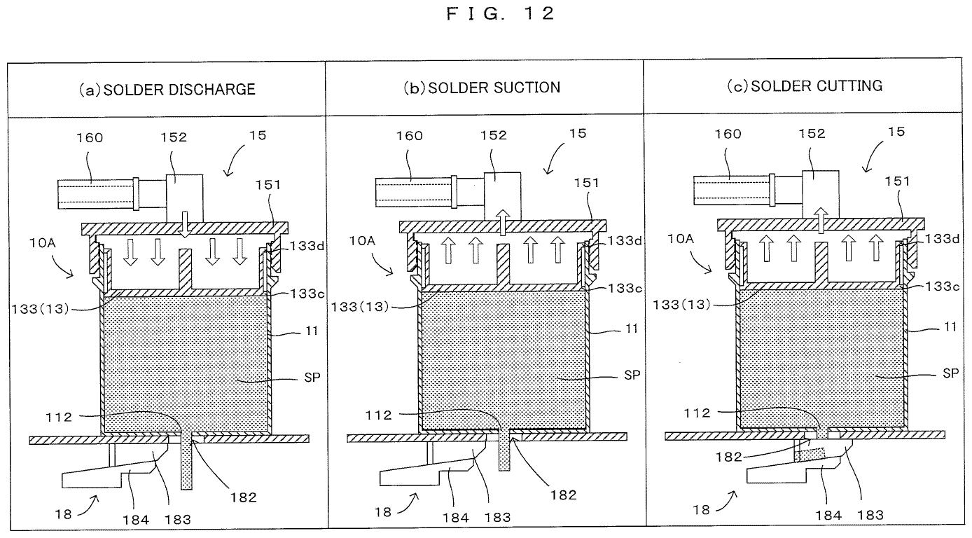

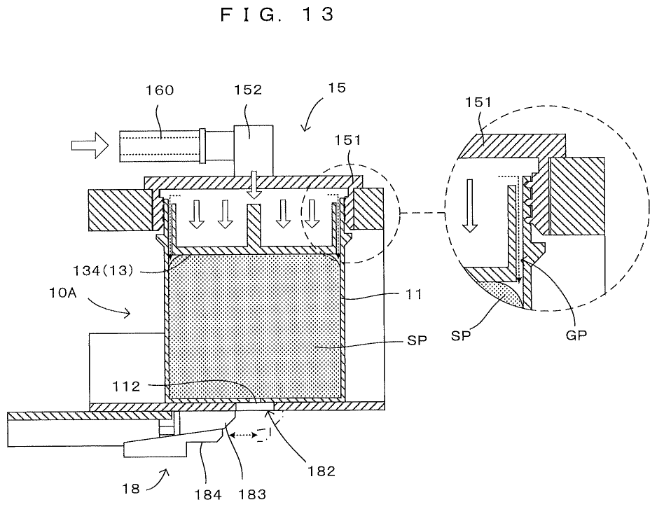

FIG. 11 is a diagram showing a storage pot and an adapter and an outer lid to be attached to the storage pot in a second embodiment of the solder supply device according to the disclosure. FIG. 12 is a diagram schematically showing a solder discharging operation, a solder sucking operation and a solder cutting operation in the second embodiment. This second embodiment largely differs from the first embodiment in the configuration of a mover 13 and the other configuration and operation are basically the same as in the first embodiment. Therefore, the following description is centered on points of difference and the same components and the same operations are denoted by the same reference signs and not described below.

In the second embodiment, an operator prepares suppliable pots 10A1, 10A2 in the following procedure as shown in FIG. 11. That is, the operator inserts an adapter 133 functioning as an example of a “moving member” of the disclosure into a storage space 111 after an inner lid (see 131 in FIG. 3) is removed from a purchased storage pot 11. Subsequent to that, the operator mounts an outer lid 15 on the storage pot 11. In this way, the suppliable pots 10A1, 10A2 are obtained.

The adapter 133 includes a disk member 133a having a disk shape and having a lower surface capable of contacting a liquid surface of solder SP and a tubular member 133b rising from a peripheral edge part of the disk member 133a and having a tubular shape inside a container inner wall of the storage pot 11, and has a cup shape open upward. Further, a first projecting part 133 and a second projecting part 133d project outward from the side surface of the tubular member 133b. More particularly, the first projecting part 133c is in the form of a flange provided on a lower end part of the side surface of the tubular member 133b and a side part thereof is provided to be slidable in contact with the container inner wall of the storage pot 11. Further, the second projecting part 133d is in the form of a flange provided on an upper end part of the side surface of the tubular member 133b and a side part thereof is provided to be slidable in contact with the container inner wall of the storage pot 11. Accordingly, the adapter 133 inserted into the storage space 111 is movable in the vertical direction while the first and second projecting parts 133c, 133d slide in contact with the inner wall of the storage pot 11 and the lower surface of the disk member 133a is held in contact with the liquid surface of the solder SP as shown in FIG. 12. Therefore, as in the first embodiment, a solder discharge process and a solder suction process are respectively performed. That is, if compressed air is given to the suppliable pot 10A as shown in field (a) of FIG. 12, the mover 13 (=adapter 133) moves downward and the solder SP is pushed out downward from a discharge port 112. By this solder discharge process, the solder SP is supplied to the upper surface of a mask M. Further, if a negative pressure is given to the suppliable pot 10A, i.e. if air is sucked into a non-storage region R2, the mover 13 (=adapter 133) moves upward and, accordingly, the solder SP hanging down from the discharge port 112 is sucked toward the storage space 111.

Further, each of the first and second projecting parts 133c, 133d is provided with a plurality of cut parts 133e at equal angular intervals. Thus, with the adapter 133 inserted in the storage space 111 as indicated by a dotted-line arrow in FIG. 11, gas components can flow in the vertical direction along the inner wall surface of the storage pot 11. That is, the cut parts 133e serve as escape paths for air. Therefore, as shown in FIG. 12, the adapter 133 is stably movable in the vertical direction according to the application of a positive or negative pressure to the non-storage region R2 with the side parts of the first and second projecting parts 133c, 133d sliding in contact with the container inner wall of the storage pot 11.

Furthermore, also in the adapter 133, a projecting member 133f projects from a central part of the upper surface of the disk member 133a toward a container opening as in the first embodiment. Thus, operator's placing operation of placing the adapter 133 on the upper surface of the inner lid 131 and take-out operation of the adapter 133 are facilitated.

FIG. 13 is a diagram schematically showing a solder discharging operation in a third embodiment of the solder supply device according to the disclosure. In the third embodiment, an adapter 134 not including the first and second projecting parts 133c, 133d is used instead of the adapter 133 used in the second embodiment. Thus, the outer side surface of the adapter 134 is separated from the container inner wall of the storage pot 11 by a minute distance. That is, a ring-shaped minute gap GP is formed between the container inner wall of the storage pot 11 and the adapter 134 and serves as a path for compressed air. Accordingly, if the compressed air is given to the suppliable pot 10A, a mover 13 (=adapter 134) moves downward and the solder SP is pushed out downward from a discharge port 112. By this solder discharge process, solder SP is supplied to the upper surface of a mask M. Further, during the solder discharge process, part of the compressed air (dotted line in FIG. 13) is fed to between the container inner wall of the storage pot 11 and the solder SP under pressure via the minute gap GP as shown in a partial enlarged view of FIG. 13. Therefore, the following functions and effects are obtained besides the effects similar to those of the above embodiments.

In the apparatus described in JP 2015-174119A, the pushing member is pushed down by the pressing cylinder while sliding in contact with the container. Thus, the solder tended to remain on the inner wall of the container and it was difficult to efficiently supply the solder. In contrast, in the third embodiment, air is fed under pressure to the solder SP in contact with the container inner wall of the storage pot 11 via the minute gap GP. In this way, the solder SP is also discharged downward via the discharge port 112. As a result, the amount of the solder remaining on the container inner wall of the storage pot 11 can be reduced and the solder SP can be efficiently supplied to the mask M.

Note that the disclosure is not limited to the embodiments described above and various changes other than the aforementioned ones can be made without departing from the gist of the disclosure. For example, in the above embodiments, the solder supply mechanism 10 in which two suppliable pots 10A are provided side by side in the pot holder 12 is an example of a “solder supply device” of the disclosure and the disclosure is applied to this solder supply mechanism 10, but the number of the suppliable pots 10A is not limited to “2”. For example, three or more suppliable pots 10A may be provided side by side. Further, the disclosure is applicable also to a solder supply mechanism (solder supply device) for supplying solder using a single suppliable pot 10A.

Further, although the positive pressure and the negative pressure are switched and the supply destinations thereof are switched using the air operate valves 163, 164 in the above embodiments, the mover drive mechanism 16 may be configured to switch using other valves.

This disclosure can be applied to solder supply techniques in general for discharging and supplying solder stored in a storage pot from a discharge port provided in a bottom part of the storage pot.

What is claimed is:

1. A solder supply device, comprising:
a storage pot including a storage space configured to store solder and a discharge port in a bottom part to communicate with the storage space such that the solder is dischargeable downward from the discharge port;
a mover movable in a vertical direction in the storage space while covering the solder stored in the storage space from above;
a mover drive mechanism including a first opening/closing part configured to switch pressure feed and pressure feed stop of air to a non-storage region and configured to push down the mover by feeding the air under pressure to the non-storage region by way of the first opening/closing part, the non-storage region being above the mover in the storage space; and
a controller configured to control the mover drive mechanism to discharge the solder from the discharge port by pushing down the mover.

2. The solder supply device according to claim 1, wherein:
the storage pot includes a concave-shaped container having an inside functioning as the storage space while being open upward, the storage pot including the discharge port in the bottom part,
the mover includes an inner lid and a moving member, the inner lid being movable in the vertical direction while a side surface thereof slides in contact with an inner wall of the container and a lower surface thereof is held in contact with a liquid surface of the solder, the moving member being movable in the vertical direction integrally with the inner lid in a state placed on an upper surface of the inner lid,
the mover drive mechanism further includes an outer lid configured to mount on the container to close an opening of the container with the inner lid and the moving member inserted in the storage space, and
the first opening/closing part is connected to the outer lid to communicate with the non-storage region sandwiched by the outer lid and the moving member.

3. The solder supply device according to claim 2, wherein:
the outer lid is attachable to and detachable from the container, and
the moving member includes a lower surface to be held in contact with the upper surface of the inner lid, an upper surface facing the non-storage region and a projecting member projecting from a central part of the upper surface toward the opening of the container.

4. The solder supply device according to claim 1, wherein:
the storage pot includes a concave-shaped container having an inside functioning as the storage space while being open upward, the storage pot being including the discharge port in the bottom part,
the mover includes a moving member movable in the vertical direction while a side surface thereof slides in contact with an inner wall of the container and a lower surface thereof is held in contact with a liquid surface of the solder,
the mover drive mechanism further includes an outer lid to be mounted on the container to close an opening of the container with the moving member inserted in the storage space, and
the first opening/closing part is connected to the outer lid to communicate with the non-storage region sandwiched by the outer lid and the moving member.

5. The solder supply device according to claim 4, wherein:
the moving member further includes:
a disk member having the lower surface;
a tubular member rising from a peripheral edge part of the disk member and having a tubular shape inside the inner wall of the container; and
a first projecting part projecting outward from a lower end part of a side surface of the tubular member and to be held in sliding contact with the inner wall of the container.

6. The solder supply device according to claim 5, further comprising:
a second projecting part projecting outward from an upper end part of the side surface of the tubular member and to be held in sliding contact with the inner wall of the container.

7. The solder supply device according to claim 6, wherein:
the first and second projecting parts include cut parts.

8. The solder supply device according to claim 1, wherein:
the storage pot includes a concave-shaped container having an inside functioning as the storage space while being open upward, the storage pot including the discharge port in the bottom part,
the mover includes a moving member movable in the vertical direction while a side surface is facing and separated from an inner wall of the container by a minute distance and a lower surface is held in contact with a liquid surface of the solder,
the mover drive mechanism further includes an outer lid to be mounted on the container to close an opening of the container with the moving member inserted in the storage space, and
the first opening/closing part is connected to the outer lid to communicate with the non-storage region sandwiched by the outer lid and the moving member.

9. The solder supply device according to claim 4, wherein:
the outer lid is attachable to and detachable from the container, and
the moving member includes an upper surface facing the non-storage region and a projecting member projecting from a central part of the upper surface toward the opening of the container.

10. The solder supply device according to claim 1, wherein:
the mover drive mechanism includes a second opening/closing part configured to switch suction and suction stop of the air from the non-storage region and configured to pull up the mover by sucking the air from the non-storage region by way of the second opening/closing part, and
the controller is configured to control the mover drive mechanism to suck the solder from the discharge port by the mover being pulled up due to a pressure drop in the non-storage region.

11. The solder supply device according to claim 10, wherein:
the controller is configured to control the mover drive mechanism to:
switch the first and second opening/closing parts respectively to pressure feed and suction stop when the solder is supplied, and
switch the first and second opening/closing parts respectively to pressure feed stop and suction while the supply of the sold is stopped.

12. The solder supply device according to claim 11, wherein:
the mover drive mechanism includes:
a pressure feeder configured to feed the air under pressure;
a sucker configured to suck the air; and
a flow passage switching valve including a first port to be connected to the non-storage region, a second port to be connected to the pressure feeder and a third port to be connected to the sucker, the flow passage switching valve functioning as the first opening/closing part by connecting and disconnecting the second port to and from the first port and functioning as the second opening/closing part by connecting and disconnecting the third port to and from the first port.

13. The solder supply device according to claim 1, further comprising:
a cutter mechanism configured to cut the solder hanging down from the discharge port at a position right below the discharge port.

14. The solder supply device according to claim 13, wherein:
the cutter mechanism includes a cutter configured to cut the solder hanging down from the discharge port and a solder collector configured to receive and collect the solder dropping down by being cut by the cutter.

15. The solder supply device according to claim 1, further comprising:
a pot holder configured to hold a plurality of the storage pots side by side in a horizontal direction, wherein:
the controller is configured to select one of the plurality of storage pots as a selected pot and control the mover drive mechanism to discharge the solder from the discharge port of the selected pot by pushing down the mover in the storage space of the selected pot.

16. The solder supply device according to claim 15, further comprising:
a remaining amount detector configured to detect a remaining amount of the solder of each storage pot, wherein:
the controller is configured to select the selected pot from the storage pots not selected as the selected pot and control the mover drive mechanism to discharge the solder from the discharge port of the selected pot by pushing down the mover in the storage space of the newly selected pot if it is detected by the remaining amount detector that the solder remaining in the selected pot has fallen below a set value set in advance.

17. A solder supply method, comprising:
providing a mover movably in a vertical direction in a storage space while covering solder from above for the storage pot having the solder stored in the storage space; and
feeding air under pressure to a non-storage region above the mover in the storage space, thereby increasing a pressure in the non-storage region and discharging the solder from a discharge port communicating with a bottom part of the storage space by pushing down the mover according to a pressure increase.

18. A printing apparatus, comprising:
the solder supply device according to claim 1, configured to supply solder to a surface of a mask overlapped on a board, and
a printing mechanism configured to print the solder on the board in a pattern corresponding to the mask by moving the solder supplied form the solder supply device on the surface of the mask.

19. A printing apparatus, comprising:
the solder supply device according to claim 2, configured to supply solder to a surface of a mask overlapped on a board, and
a printing mechanism configured to print the solder on the board in a pattern corresponding to the mask by moving the solder supplied form the solder supply device on the surface of the mask.

20. The solder supply device according to claim 5, wherein:
the outer lid is attachable to and detachable from the container, and
the moving member includes an upper surface facing the non-storage region and a projecting member projecting from a central part of the upper surface toward the opening of the container.
